(19) United States
(12) Patent Application Publication
(10) Pub. No.: US 2014/0009837 A1
(43) Pub. Date: Jan. 9, 2014

(54) SUPPORTING STRUCTURE IN A FLAT-PLATE DISPLAY AND METHOD FOR MAKING SAME

(71) Applicants: Meng-Chang Liu, Hsinchu (TW); Meng-Jia Hsiao, Hsinchu (TW)

(72) Inventors: Meng-Chang Liu, Hsinchu (TW); Meng-Jia Hsiao, Hsinchu (TW)

(73) Assignee: AU OPTRONICS CORPORATION, Hsinchu (TW)

(21) Appl. No.: 13/542,881

(22) Filed: Jul. 6, 2012

(51) Int. Cl. G02B 5/02; B29C 65/48

(52) U.S. Cl. 359/599; 156/65

(57) ABSTRACT

A method for providing a supporting structure in a flat-plate display is disclosed. The display has a display panel, a diffuser panel, a reflector panel to reflect light from a backlight unit towards the diffuser panel in order to illuminate the display panel. The supporting structure has a plurality of support pins located in that gap between the diffuser panel and the reflector panel for supporting the diffuser panel. The support pins are either molded with the diffuser panel, fused into the diffuser panel or attached to the diffuser panel using an index matching optical adhesive.

### FIELD OF THE INVENTION

The present invention relates to a flat-plate display and, in particular, to the supporting structure in the flat-plate display.

### BACKGROUND OF THE INVENTION

A flat-plate display, in general, has a display panel where a layer of thin-film transistors is used to control a plurality of display elements illuminated by a backlight source. Between the backlight source and the display panel, a diffuser panel is used to diffuse the light provided by the backlight source. Furthermore, a reflector is placed adjacent to the backlight source to reflect the light provided by the backlight source to the diffuser panel. The diffuser panel is spaced from the reflector and the backlight source, leaving a gap therebetween.

The present invention is concerned with providing a supporting structure in the flat-plate display. In particular, the supporting structure is located in the gap between the diffuser panel and the backlight source/reflector.

### SUMMARY OF THE INVENTION

The present invention provides a flat-plate display with a supporting structure. If the supporting structure includes a plurality of support pins placed in the gap between the diffuser panel and the backlight source to support the diffuser panel, dark spots usually appear on the display panel at the locations above the support pins due to the reflection losses between the diffuser panel and the support pins. According to various embodiments of the present invention, the dark spots associated with the supporting pins are reduced or eliminated.

Thus, the first aspect of the present invention is a method for use in a display. The method comprises:

providing a supporting structure in the display, the display comprising a diffuser panel and a reflector panel spaced from the diffuser panel, defining a gap therebetween, wherein the supporting structure comprises a plurality of support pins located in the gap; and

joining the support pins to the diffuser panel such that the absolute value of a refractive index difference, if existing, between the diffuser panel and the support pins is smaller than 0.3.

According to some embodiments of the present invention, when the diffuser panel and the support pins are made of the same material, said joining comprises molding the support pins with the diffuser panel and the molding comprises injection molding.

According to some embodiments of the present invention, the joining comprises fusing one end of the support pins onto the diffuser panel and the fusing comprises applying ultrasonic waves to the one end of the support pins.

According to some embodiments of the present invention, the diffuser panel is made of a first material comprising a first refractive index and the support pins are made of a second material comprising a second refractive index different from the first refractive index.

According to some embodiments of the present invention, the diffuser panel is made of a first material comprising a first refractive index and the support pins are made of a second material comprising a second refractive index substantially equal to the first refractive index.

According to some embodiments of the present inventions, the joining comprises providing an optical adhesive between the diffuser panel and one end of the support pins. When the diffuser panel is made of a first material comprising a first refractive index and the support pins are made of a second material comprising a second refractive index, and the optical adhesive comprises a third refractive index, the method further comprises:

selecting the optical adhesive such that the third refractive index has a value between the first refractive index and the second refractive index.

According to some embodiments of the present invention, when the diffuser panel is made of a first material comprising a first refractive index and the support pins are made of a second material comprising a second refractive index substantially equal to the first refractive index, and the optical adhesive comprises a third refractive index, the method further comprises:

selecting the optical adhesive such that the absolute difference between the first refractive index and the third refractive index is smaller than 0.02.

The second aspect of the present invention is a display comprising:

a diffuser panel;

a reflector panel configured to reflect light towards the diffuser panel, the reflector panel spaced from the diffuser panel defining a gap therebetween; and

a supporting structure located in the gap, the supporting structure comprising a plurality of support pins attached to the diffuser panel such that the absolute value of a refractive index difference, if existing, between the diffuser panel and the support pins is smaller than 0.3.

According to some embodiments of the present invention, when the diffuser panel and the support pins are made of the same material, the support pins are molded with the diffuser panel.

According to one embodiment of the present invention, in the support pins are molded with the diffuser panel by injection molding.

According to some embodiments of the present invention, one end of the support pins is fused onto the diffuser panel.

According to one embodiment of the present invention, the support pins are fused onto the diffuser panel by ultrasonic welding.

According to various embodiments of the present invention, the diffuser panel is made of a first material comprising a first refractive index and the support pins are made of a second material comprising a second refractive index different from or substantially equal to the first refractive index.

According to some embodiments of the present invention, the support pins are attached to the diffuser panel by an optical adhesive provided between the diffuser panel and one end of each of the support pins.

According to one embodiment of the present invention, when the diffuser panel is made of a first material comprising a first refractive index and the support pins are made of a second material comprising a second refractive index, and the optical adhesive comprises a third refractive index, the optical adhesive is selected such that the third refractive index has a value between the first refractive index and the second refractive index.

According to another embodiment of the present invention, when the diffuser panel is made of a first material comprising a first refractive index and the support pins are made of a second material comprising a second refractive index substantially equal to the first refractive index, and the optical adhesive comprises a third refractive index, the optical adhesive is selected such that the absolute difference between the first refractive index and the third refractive index is smaller than 0.02.

### BRIEF DESCRIPTION OF THE DRAWINGS

FIG. 1 illustrates a flat display according to the present invention.

FIG. 2a illustrates the interface between the diffuser panel and one of the support pins.

FIG. 2b illustrates the losses in transmitted light due to multiple reflections.

FIG. 3a illustrates a support pin molded with the diffuser panel, according to one embodiment of the present invention.

FIG. 3b illustrates a support pin fused into the diffuser panel, according to another embodiment of the present invention.

FIG. 3c illustrates a support pin attached to the diffuser panel using an optical adhesive, according to a different embodiment of the present invention.

FIG. 3d illustrates the losses in transmitted light when the support pins are attached to the diffuser panel using an optical adhesive.

### DETAILED DESCRIPTION

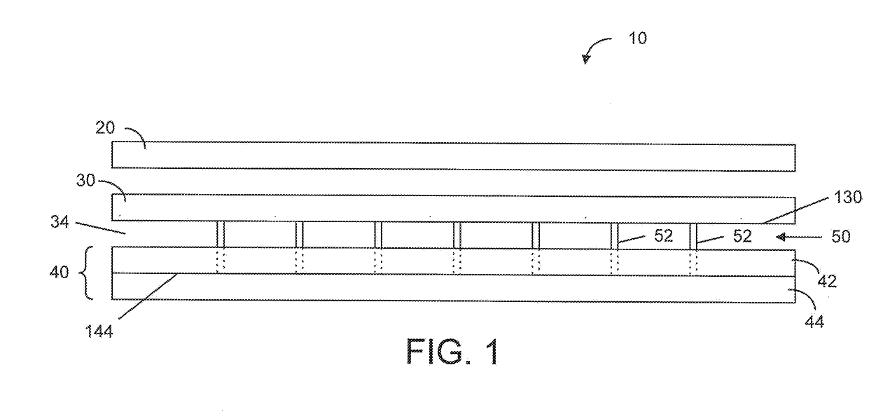

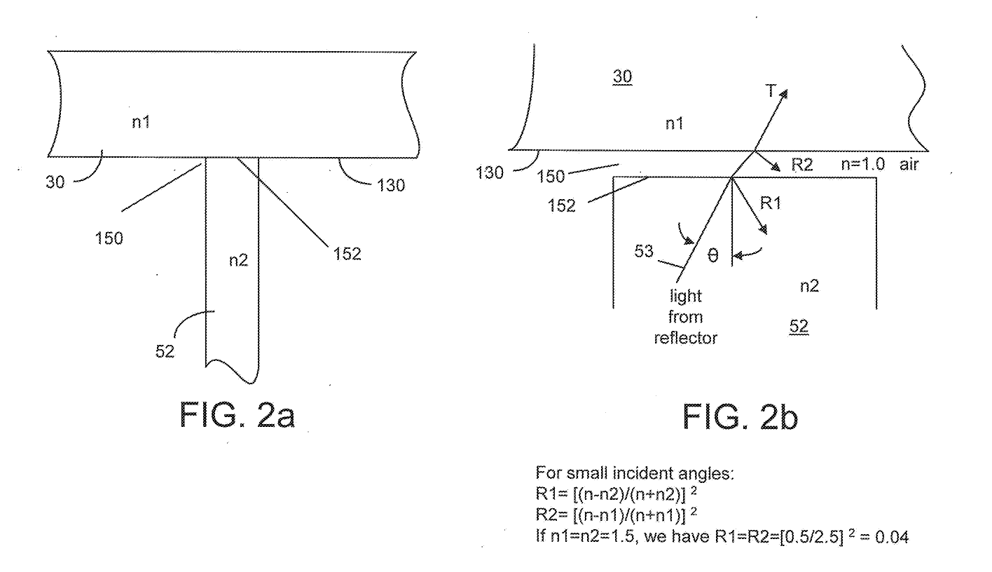

The present invention is concerned with providing a supporting structure in a flat-plate display. As shown in FIG. 1, the flat-plate display 10 has a display panel 20, a diffuser or diffuser panel 30, a backlight unit 40. The display panel 20 comprises a plurality of picture elements controlled by a thin-film transistor layer (not shown). In a transmissive or transflective display, the display panel 20 is illuminated by the backlight unit 40 through the diffuser panel 30. The diffuser panel 30 is spaced from the backlight unit 40 such that there is a gap 34 between the diffuser panel 30 and the backlight unit 40. The backlight unit 40 may comprise a backlight source 42 to provide the illuminating light and a reflector 44 to reflect part of the illuminating light toward the diffuser panel 30. The present invention is concerned with providing a supporting structure 50 in the gap 34. The supporting structure 50 comprises a plurality of support pins 52. Depending on the physical layout of the backlight unit 40, it is possible that one end of the support pin 52 is located on the surface 144 of the reflector 44 and the other end of the support pin 52 is touching the lower surface 130 of the diffuser panel 30. Let us assume that the diffuser panel 30 is made of a material having a refractive index n1 and the support pins 52 are made of a material having a refractive index n2. In general, if the diffuser panel 30 is resting on the support pins 52 as shown in FIG. 2a, the interface 150 between the upper surface 152 of the support pins 52 and the lower surface 130 of the diffuser panel 30 comprises an air gap as shown in FIG. 2b. When a light beam 53 encounters the upper surface 152, part of the light beam 53 will be reflected due to the refractive index difference between n2 and air (n=1.0). The transmitted portion through the upper surface 152 will also be reflected at the lower surface 130 of the diffuser panel 30 due to the refractive index difference between n1 and air.

The present invention provides a method and a supporting structure configured to eliminate or reduce the losses in the transmitted light from the support pin 52 through the interface 150 into the diffuser panel 30. The losses in the transmitted light can be estimated using Fresnel reflection equation, which is well known. As shown in FIGS. 2a and 2b, the refractive index of the diffuser panel 30 is n1 and the refractive index of the support pin 52 is n2. There will be two reflections R1 and R2 and the transmission coefficient T is approximately given by T=1−R1−R2, which is dependent on the incident angle θ. For simplicity, let us assume n1=n2=1.5. With the refractive index of air being n=1, the refractive index difference is Δn=±0.5. The reflection coefficient (R1=R2=R, approximately) and the transmission coefficient (T=1−2R) are given below:

| Incident angle θ (degrees) | R | T |
|---|---|---|
| 0 | 0.04 | 0.92 |
| 25 | 0.075 | 0.85 |
| 35 | 0.17 | 0.66 |
| 40 | 0.39 | 0.22 |
| >41.8 | R1 = TIR | 0 |

It should be noted that, when the incident angle is larger than 41.8 degrees, total-internal-reflection (TIR) occurs at the interface 152 (at the upper surface of the support pin 52). As such, the light beam does not reach the diffuser panel 30. The TIR angle is less than 45 degrees and, therefore, only a small part of the light beams from the reflector will be transmitted into the diffuser panel 30. Due to the reflection losses at the interface 150 between the diffuser panel 30 and the support pin 52, a darker spot appears on the display panel 20. The number of darker spots on the display panel 20 is dependent on the number of the support pins 52.

According to various embodiments of the present invention, the losses in the transmitted light can be eliminated or reduced by reducing the refractive index difference, Δn, at the interface 150 between the lower surface 130 of the diffuser panel 30 and the upper surface 152 of the support pin 52.

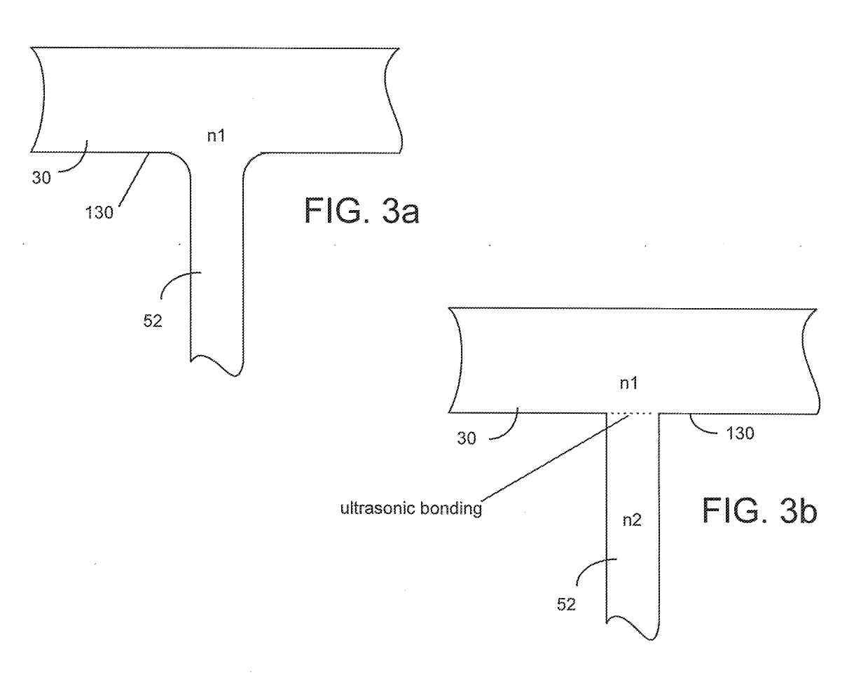

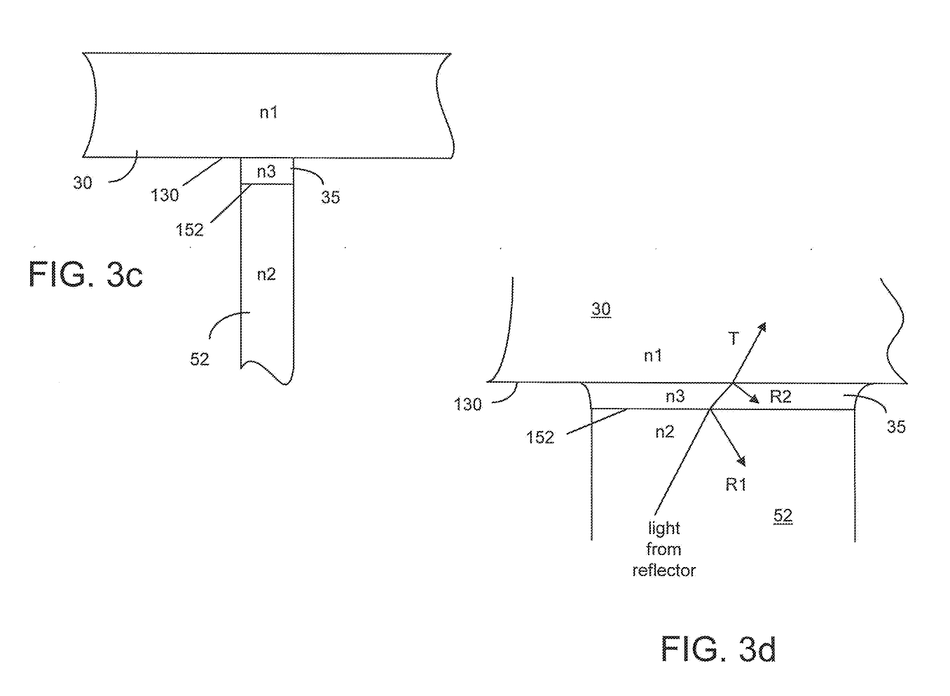

According to one embodiment of the present invention, the support pins 52 are produced in the same process as the diffuser panel 30. For example, if the diffuser panel 30 is made of plastic or polymer produced by injection molding, then the support pins 52 can be produced by injection molding in the same process. As such, there is no gap between the lower surface 130 of the diffuser panel 30 and each of the support pins 52 (see FIG. 3a). Since there is no interface between the lower surface 130 of the diffuser panel 30 and each of the support pins 52, there are no reflection losses between the lower surface 130 of the diffuser panel 30 and the support pins 52.

According to another embodiment of the present invention, the support pins 52 are fused onto the lower surface 130 of the diffuser panel 30. For example, ultrasonic welding can be used to join the support pins 52 to the lower surface 130 of the diffuser panel 30 as shown in FIG. 3b. Ultrasonic welding applies high-frequency ultrasonic acoustic vibrations to the upper end of each support pin 52 to create a solid-state weld. Since ultrasonic welding can be used to join dissimilar materials together, the refractive index n2 of the support pins 52 can be the same as or different from the refractive index n1 of the diffuser panel 30. In any case, the air gap at the interface 150 (see FIGS. 2b) is eliminated. It should be noted that ultrasonic welding is used here as an example. There may be many other joining techniques that can be used for joining the support pins 52 to the lower surface 130 of the diffuser panel 30 without resulting in an abrupt change in the refractive index in the path of a light beam from a support pin to the diffuser panel. For example, there are methods that can be used to temporarily melt either the upper surface 152 of a support pin 52 or the lower surface 130 of the diffuser panel 30, or both, for the joining purpose.

According to yet another embodiment of the present invention, the support pins 52 are attached to the lower surface 130 of the diffuser panel 30 using a joining medium. For example, an optical adhesive 35 is used to join the support pins 52 to the lower surface 130 of the diffuser panel 30 as shown in FIG. 3c. As shown in FIG. 3c, the refractive index of the diffuser panel 30 is n1, the refractive index of the support pin 52 is n2 and the refractive index of the optical adhesive 35 is n3. It is understood that, before the optical adhesive 35 is cured, it is a liquid or gel so that there are effectively no air gaps existing between the optical adhesive 35 and the diffuser panel 30 and between the optical adhesive 35 and the support pin 52. Thus, it is possible to substantially eliminate the losses in the transmitted light due to the reflections at an air gap. For example, if the refractive indices of the diffuser panel 30 and the support pins 52 are substantially the same, or n1=n2, it is possible to select an optical adhesive 35 with a refractive index n3 which is substantially equal to n1.

If n1 is not the same as n2, it is possible to select an optical adhesive 35 with a refractive index n3 having a value between n1 and n2 to reduce the reflection losses. For example, if n1=1.50 and n2=1.60, it is possible to select an optical adhesive with a refractive index n3=1.55 such that Δn=±0.05. In this particular case, the losses in the transmitted light can be estimated as follows:

| Incident angle θ (degrees) | R | T |
|---|---|---|
| 0 | 0.00025 | 0.9995 |
| 25 | 0.0004 | 0.9992 |
| 35 | 0.0006 | 0.9988 |
| 45 | 0.0010 | 0.998 |
| 60 | 0.005 | 0.99 |
| >75.7 | R = TIR | 0 |

Thus, in this particular example, the transmission losses in this case are mainly due to reflections at very large incident angles and the total-internal-reflection.

It should be noted that most plastics have refractive indices between 1.3 and 1.7, and the refractive indices of the optical adhesive are between 1.32 and 1.57. If n1=1.7 and n2=1.3, it is possible to select an optical adhesive with n3=1.50 so that Δn=±0.2. The losses in the transmitted light can be estimated as follows:

| Incident angle θ (degrees) | R | T |
|---|---|---|
| 0 | 0.0051 | 0.99 |
| 25 | 0.0071 | 0.984 |
| 35 | 0.010 | 0.98 |
| 45 | 0.016 | 0.978 |
| 60 | 0.043 | 0.91 |
| No TIR | | |

The losses in the transmitted light can be greatly reduced even when there is a substantial refractive index difference between the optical adhesive 35 and the diffuser panel 30, and between the optical adhesive 35 and the support pin 52. For example, when n1=n2=1.59 and n3=1.32 (with Δn=±0.27), the losses in the transmitted light are estimated as follows:

| Incident angle θ (degrees) | R | T |
|---|---|---|
| 0 | 0.0086 | 0.983 |
| 25 | 0.014 | 0.972 |
| 35 | 0.024 | 0.952 |
| 45 | 0.057 | 0.886 |
| 55 | 0.38 | 0.24 |
| >56.1 | R = TIR | 0 |

It should be understood that, there is no reason why one chooses such an optical adhesive with Δn=±0.27. The above calculation is only used to demonstrate that it is possible to reduce the reflection losses by attaching a support pin to the diffuser panel such that the absolute value of a refractive index difference, if existing, between the diffuser panel and the support pins is smaller than 0.3.

In an extreme case when both the diffuser panel 30 and the support pins 52 are made of materials with n1=n2=1.7, it is possible to select the optical adhesive having the highest refractive index or n3=1.57 (with Δn=±0.13).

| Incident angle θ (degrees) | R | T |
|---|---|---|
| 0 | 0.0016 | 0.998 |
| 25 | 0.0024 | 0.995 |
| 35 | 0.0038 | 0.992 |
| 45 | 0.0075 | 0.985 |
| 55 | 0.0217 | 0.957 |
| >67.5 | R = TIR | 0 |

When the refractive index of the plastic is n1=n2=1.3, an optical adhesive having a low refractive index such as 1.32 should be used, or Δn=±0.02.

In the various embodiments of the present invention, the losses in the transmitted light can be reduced by choosing the refractive index difference, Δn, for the interface between the diffuser panel 30 and the support pin 52 to be smaller than, say, ±0.3. When the refractive index of the diffuser panel 30 and the support pin 52 is around 1.5, an optical adhesive having a refractive index between 1.48 and 1.52 should be used for attaching the support pin 52 to the lower surface 130 of the diffuser panel 30. As such, the absolute refractive index difference between the optical adhesive and the diffuser panel/support pins is equal to or smaller than 0.02.

In summary, when the support pins are molded with the diffuser panel, the losses in transmitted light can be effectively eliminated. When the support pins are fused with the diffuser panel, the losses in transmitted light are greatly reduced or eliminated. When the support pins are attached to the diffuser panel using an optical adhesive, the optical adhesive can be selected such that the absolute difference between the optical adhesive and the diffuser panel/support pins can be reduced to 0.3 or smaller. It is also possible to select the optical adhesive such that the absolute difference is reduced to 0.05 or 0.02 and smaller. With the various embodiments of the present invention, the darker spots on the display panel due to the losses in the transmitted light (from the reflector to the diffuser panel) can be eliminated or made less visible.

Although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in a display, comprising:
providing a supporting structure in the display, the display comprising a diffuser panel and a reflector panel spaced from the diffuser panel, defining a gap therebetween, wherein the supporting structure comprises a plurality of support pins located in the gap; and
joining the support pins to the diffuser panel such that the absolute value of a refractive index difference, if existing, between the diffuser panel and the support pins is smaller than 0.3.

2. The method according to claim 1, wherein the diffuser panel and the support pins are made of the same material and wherein said joining comprises molding the support pins with the diffuser panel.

3. The method according to claim 2, wherein said molding comprises injection molding.

4. The method according to claim 1, wherein said joining comprises fusing one end of the support pins onto the diffuser panel.

5. The method according to claim 4, wherein said fusing comprises applying ultrasonic waves to the one end of the support pins.

6. The method according to claim 4, wherein the diffuser panel is made of a first material comprising a first refractive index and the support pins are made of a second material comprising a second refractive index different from the first refractive index.

7. The method according to claim 4, wherein the diffuser panel is made of a first material comprising a first refractive index and the support pins are made of a second material comprising a second refractive index substantially equal to the first refractive index.

8. The method according to claim 1, wherein said joining comprises providing an optical adhesive between the diffuser panel and one end of the support pins.

9. The method according to claim 8, wherein the diffuser panel is made of a first material comprising a first refractive index and the support pins are made of a second material comprising a second refractive index, and the optical adhesive comprises a third refractive index, said method further comprising:
selecting the optical adhesive such that the third refractive index has a value between the first refractive index and the second refractive index.

10. The method according to claim 8, wherein the diffuser panel is made of a first material comprising a first refractive index and the support pins are made of a second material comprising a second refractive index substantially equal to the first refractive index, and the optical adhesive comprises a third refractive index, said method further comprising:
selecting the optical adhesive such that the absolute difference between the first refractive index and the third refractive index is smaller than 0.02.

11. A display comprising:
a diffuser panel;
a reflector panel configured to reflect light towards the diffuser panel, the reflector panel spaced from the diffuser panel defining a gap therebetween; and
a supporting structure located in the gap, the supporting structure comprising a plurality of support pins attached to the diffuser panel such that the absolute value of a refractive index difference, if existing, between the diffuser panel and the support pins is smaller than 0.3.

12. The display according to claim 11, wherein the diffuser panel and the support pins are made of the same material and wherein the support pins are molded with the diffuser panel.

13. The display according to claim 12, wherein the support pins are molded with the diffuser panel by injection molding.

14. The display according to claim 11, wherein one end of the support pins is fused onto the diffuser panel.

15. The display according to claim 14, wherein the support pins are fused onto the diffuser panel by ultrasonic welding.

16. The display according to claim 14, wherein the diffuser panel is made of a first material comprising a first refractive index and the support pins are made of a second material comprising a second refractive index different from or substantially equal to the first refractive index.

17. The display according to claim 11, wherein the support pins are attached to the diffuser panel by an optical adhesive provided between the diffuser panel and one end of each of the support pins.

18. The display according to claim 17, wherein the diffuser panel is made of a first material comprising a first refractive index and the support pins are made of a second material comprising a second refractive index, and the optical adhesive comprises a third refractive index, and wherein the optical adhesive is selected such that the third refractive index has a value between the first refractive index and the second refractive index.

19. The display according to claim 17, wherein the diffuser panel is made of a first material comprising a first refractive index and the support pins are made of a second material comprising a second refractive index substantially equal to the first refractive index, and the optical adhesive comprises a third refractive index, and wherein the optical adhesive is selected such that the absolute difference between the first refractive index and the third refractive index is smaller than 0.02.
